(19) United States
(12) Patent Application Publication
(10) Pub. No.: US 2019/0364089 A1
(43) Pub. Date: Nov. 28, 2019

(54) System and Method for Developing Evolving Online Profiles

(71) Applicant: Anurag Bist, Newport Beach, CA (US)

(72) Inventor: Anurag Bist, Newport Beach, CA (US)

(21) Appl. No.: 16/203,400

(22) Filed: Nov. 28, 2018

Related U.S. Application Data
(63) Continuation of application No. 13/291,054, filed on Nov. 7, 2011, now abandoned.
(60) Provisional application No. 61/474,322, filed on Apr. 12, 2011.

(51) Int. Cl. H04L 29/08; G06Q 10/10

(52) U.S. Cl. CPC H04L 67/02; H04L 67/306; G06Q 10/10

(57) ABSTRACT

A system and a method for generating an emotional profile of the user and deriving inference from the analytics of generated emotional profile is provided. The method involves sharing media content or online event in a connected environment; capturing user's reaction to the said content or event; generating an emotional profile of the user to rate the media content or event; and sharing the emotional profile within the connected environment.

### CROSS REFERENCE TO RELATED APPLICATIONS

This application is a continuation of U.S. patent application Ser. No. 13/291,057, filed Nov. 7, 2011, currently pending, which claims the benefit of provisional patent application number U.S. 61/474,322 titled “System and Method for Generation, Evolution and Interaction of Real Time Online Emotional Profiles”, filed Apr. 12, 2011, in the United States Patent and Trademark Office, the disclosures of which is incorporated herein by reference in their entireties.

### FIELD OF THE INVENTION

The present invention relates generally to system and method for developing interactive real time online user's profiles, and more particularly, to a system and method for generation, evolution and interaction of real time online emotional profiles.

### BACKGROUND OF THE INVENTION

With the growth of connected infrastructure, more and more human interactions are happening online through instant messaging, real time interactions on online social communities, or interactions facilitated with next generation mobile and connected devices that include smart phones, internet tablets, gaming consoles, and more traditional laptops and computer terminals. One key desire of these interactions is the ability to accurately convey an individual's emotions during such online interactions.

Currently such emotions are being conveyed by individuals in a deliberate manner by text or other visual cues. There even exist methods for automatically detecting individual emotions based on a variety of sensory, auditory and visual inputs.

However, the currently known technologies don't provide a solution that addresses a uniform method of conveying an individual's emotions in a connected environment that can be scaled across a number of online social interactions.

The current invention introduces a generic system and method for representing, generation, evolution and usage of online individual emotional profiles that could be used in all kinds of online one-on-one or social community interactions.

As such there is need for creating a general infrastructure that could then be customized based on a range of variables like: (a) the number of people involved in a particular interaction (one-on-one (e.g. chat or video conferencing), broadcast (e.g. twitter), one-to-many (eg. Facebook, LinkedIn), a selected group (e.g. private groups in a corporate network), (b) the kind of connected network infrastructure available, (c) the kind of vertical application being addressed, (d) the availability of software and hardware resources and types of client devices, (e) the kind of sensory, auditory, visual and other techniques being used for detection, and (f) other variability that may include, among others, privacy, preferences, location based cues, etc.

In light of above discussion, a method and system is presented that can generate evolving emotional profiles of individuals to know their reaction to online events, online content or media and that can be used in interactions in a real time connected environment. The invention is useful in improving the communication and interactions of users over the internet. Applications include, among others, social media, entertainment, online gaming, and online commerce.

### OBJECTS OF THE INVENTION

It is a primary object of the invention to provide a system for the generation, evolution and interaction of real time online emotional profiles of individuals in a connected environment.

It is a further object of the invention to provide methods for the generation, evolution and interaction of real time online emotional profiles of individuals in a connected environment.

It is still a further object of the invention to provide a method of representing evolving emotional profiles of all client devices or individuals connected to it in a network.

A further object of the invention is to provide methods to create instantaneous time averaged emotional profiles and to make them available to each individual client device for online communication or interaction.

It is still a further object of the invention to provide a system to collect emotional states of the users from a given set of allowed emotional states.

A further object of the invention is to provide a method of generating an instantaneous emotional profile EP(i) of the individuals in a connected environment.

Yet another object of the invention is to communicate to a shared repository or a central database, stored, for example, in a cloud computing environment, updating existing instantaneous emotional profiles of users.

### BRIEF SUMMARY OF THE INVENTION

In view of the foregoing limitations, associated with the use of traditional technology, a method and a system is presented for generation, evolution and interaction of Real Time Online Profiles.

Accordingly the present invention provides a system for generation, evolution and interaction of Real Time Online Profiles.

The present invention further provides a system of generating and representing instantaneous time averaged profiles of individuals in a connected environment.

Accordingly in an aspect of the present invention, a system for generating a user's profile in an interactive environment is provided. Embodiments of the system have a networked client device with a detector having at least one sensor to capture user's input; a processor to process the input to generate the user's profile; a central repository to store the user's profile; and a server configured with a plurality of client devices to communicate the user's profile for online content and events in the user's predefined network; and able to track the user's input and interactions for updating the evolving user's profile.

In another aspect of present invention, a method for generating a user's profile in an interactive network environment is provided. Embodiments of the method have the steps of capturing inputs of the user; processing the inputs to generate a profile of the user; storing the profile in a central repository; communicating the profiles in the networked environment for online contents and events in the user's predefined network; and continuously tracking user's interaction and inputs, and updating the evolving profiles.

In yet another aspect of present invention, a method for generating a user's profile in an interactive network environment is provided. The method distributes online content, online interactions and events in a networked environment; captures reactions of the user to the content and events using at least one sensor by a client device; generates a profile of the user; stores the profile in a network repository; and communicates the profile showing a response of the user to the online content and events, within the user's network.

In yet another aspect of the present invention the user's profile designates the emotions, behavior, response or reaction of the user.

### BRIEF DESCRIPTION OF THE DRAWINGS

The invention will hereinafter be described in conjunction with the figures provided herein to further illustrate various non-limiting embodiments of the invention, wherein like designations denote like elements, and in which:

FIG. 1 illustrates a schematic representation of interacting system for representing, generating, evolution and usage of online emotional profiles of individuals in a connected network in accordance with an embodiment of the present invention.

FIG. 2 illustrates a plurality of client devices in a cloud network and a system and a method for representing, generating, evolution and usage of online emotional profile of individuals in a connected environment, in accordance with an embodiment of the present invention.

FIG. 3 illustrates the system module of a client device in accordance with an embodiment of the present invention.

FIG. 4 illustrates a flow diagram depicting a process flow for generating emotional profile and communicating it in the cloud network, in accordance with an embodiment of the present invention.

FIG. 5 illustrates an exemplary method to use the system for rating an online event and content in accordance with an embodiment of the present invention.

### DETAILED DESCRIPTION OF INVENTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances methods, procedures and components known to persons of ordinary skill in the art have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method used thereof for representing, generation, evolution and usage of an online individual profile that may be used in online one-on-one and social community interactions. The system includes a plurality of client devices that are connected in a cloud networked environment; a server in configuration with plurality of client devices to communicate user's profile; a central repository to store the profiles. The client device is a device that has connectivity to a network or internet and has the ability to capture and process input from the user. Online events and content are distributed in the interactive cloud network or other network through the server to online client devices. The user's response to these events and content are captured by one or more sensors such as webcam, microphone, accelerometer, tactile sensors, haptic sensors and GPS present in client devices in the form of user's input. These content and events are then rated on the basis of user's input present in client devices in the form of user's input. The content and events are then rated on the basis of user's input.

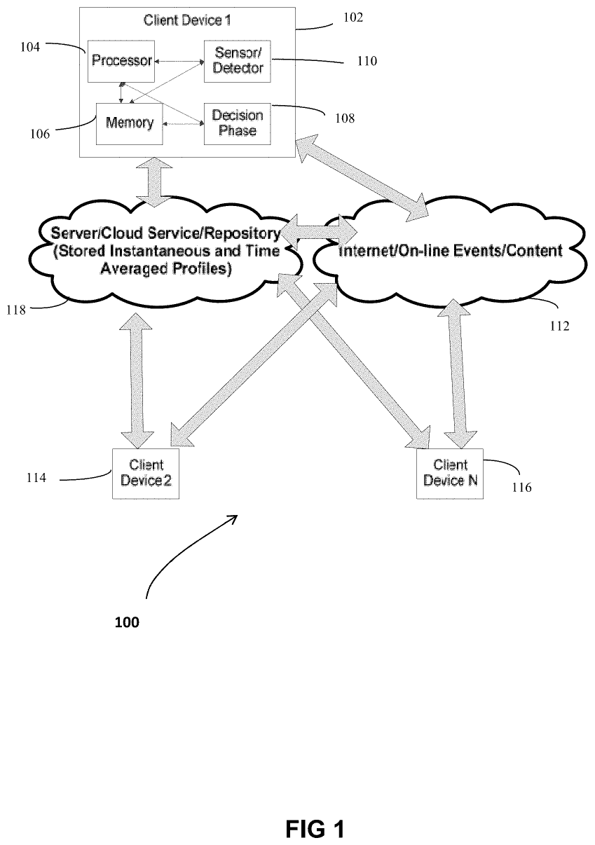

FIG. 1 illustrates a schematic representation of interacting system for representing, generating, evolution and usage of online emotional profiles of individuals in a connected network in accordance with an embodiment of the present invention. The system provides a client device 102 connected in a cloud network 118 configured with a server in the cloud. The client device 102 has a processor 104, a memory 106, a decision phase 108 and a sensor 110. The client device 102 is in connection with other client devices 114 and 116 through the server in the cloud network 118. Various on-line events and content 112 are distributed in the cloud network 118 for assessment. The client device 102 receives the distributed online content and events 112 through the server in the cloud 118 such that user of the client has an access to the distributed content and events 112.

The sensor 110 of the client device 102 is a detector that has an ability to capture some specific inputs from the user, such as video and audio of the user. These inputs reflect the emotional state of the user and are related to the stimulus or reaction generated by the user to the online content and events 112. The processor 104 of client device 102 processes the input signals received from the sensor 110 and delivers the processed input to decision phase 108. The decision phase 108 generates the profile of the user based on the response of the user to online content and events 112. Thus, the profile is a combination of the emotion, behavior, response, attention span, gestures, hand and head movement, or other reactions or stimuli of the user collected through the sensors available in the client devices and then processed. These profiles are then stored in the memory 106 of the client device 102. The client device 102 then communicates the profile to the cloud network 118 where the central repository is present. The user's profile is then stored in the central repository to communicate the profile with other client devices such as client device 2 114 and client device N 116. The users of the client device 2 114 and the client device N 116 are able to view the response of the user of the client device 1 102 to the particular content or event 112.

In an embodiment of the present invention the client device 102 is a single module or a plurality of modules able to capture the input data from the individual, to process the input data for feature extraction and has a decision phase for generating the profile of the user.

In an embodiment of the present invention, the client device 102 includes but is not limited to being a mobile phone, a smartphone, a laptop, a camera with WiFi connectivity, a desktop, tablets (iPAD or iPAD like devices), connected desktops or other sensory devices with network connectivity and processor capability.

In another embodiment of the present invention, the profile corresponds to the emotion, behavior, response, reaction or other stimuli of the user.

In another embodiment of the present invention the server in the cloud 118 has the ability to interact with the client devices 102, 114 and 116 in a real time manner. The client devices 102, 114 and 116 interact with each other through the server in the cloud 118 and generate and send the user profiles to the server. The server is configured to share whole or part of the user's profiles to a selected group of the client devices or individuals based on predefined rules set by the users. Alternatively, the client devices need not generate and send user profiles to the cloud or server, and may instead transmit data (e.g. the user response) to one or more servers which process said data to create the user profiles.

In yet another embodiment of the present invention, the user may set predefined rules based on connectivity, privacy, applications and specific rules pertaining to the online content and events 112 to allow or restrict profiling for example.

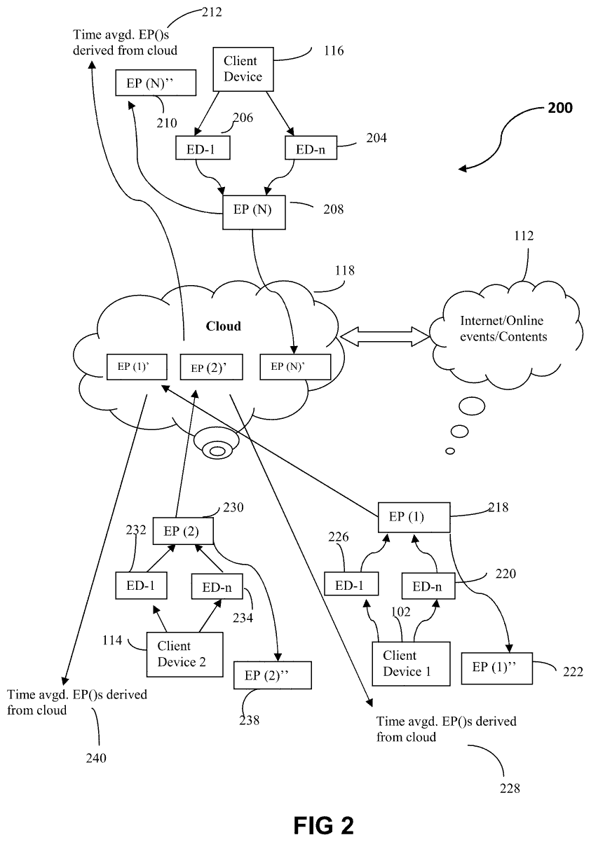

FIG. 2 illustrates a plurality of client devices in a cloud network and a system 200 and a method for representing, generating, evolution and usage of online emotional profiles of individuals in a connected environment, in accordance with an embodiment of the present invention. P (1), P (2), . . . . . . , P (N) are N individuals that are connected in a networked environment through the client device (1) 102, client device (2) 114, and client device (N) 116 respectively. The client device may be any device with connectivity to a network, or internet, and with an ability to capture and process some specific auditory, visual, text, location based, sensory or any other kind of inputs from their respective users or individuals. After capturing the user's inputs, the client device 116 then uses its processing power to use one or more Emotion detectors ED(1)206, . . . , ED(n)204 to finally generate an instantaneous Emotional Profile EP (n) 208 of the user n. Thus, the emotional profile is a combination of the emotion, behavior, response, attention span, gestures, hand and head movement, or other reactions or stimuli of the user collected through the sensors available in the client devices and then processed. The generated emotional profile EP(n) 208 is then communicated to a shared repository or a central database in the cloud 118 to update EP (n)′ and also to the client device to generate EP (n)″210.

The FIG. 2 shows N number of individuals interacting at a given time and the cloud 118 having evolving set of (EP(1)′, EP(2)′, . . . . EP(N)′) at a given time. This set of emotional profiles is translated or mapped to the individual client devices into a fixed mapping (EP(1)′″, EP(2)′″, . . . . EP(N)′″)212.

In another embodiment of the present invention, the instantaneous emotional profile (EP(n))208 detection may be modulated by the Emotional Profile (EP(n)′)in the cloud 118 as well.

In another embodiment of the present invention, the Emotional Profile EP (n) 208 is also simultaneously communicated to a central repository in the cloud 118 that may reside in a geographically different place and is connected to a plurality of other client devices.

In another embodiment of the present invention, the Emotional Profiles of the user are stored in a different format EP(n)′ and it is updated continuously temporally. EP(n)′ is the Emotional Profile of the individual “N” that is stored in the cloud 118. This profile EP(n)′ is used as a base profile in the connected network to communicate the Emotional state of the individual.

In another embodiment of the present invention, the client device 116 stores a different instantaneous version of its own individual emotional profile EP(n)″210. Since each client device may have different hardware and software configuration and capacity, therefore each client may store a different version (or format) of emotional profile.

In another embodiment of the present invention, the server in cloud 118, where the emotional profiles are being stored, is provided with the configuration to allow access of these profiles to other applications which are running on the user's client device 116. For instance, in a social networking site, if the user wants to view both the user's as well as the other people in user's network's emotional profiles that have been stored in the cloud 118, an API (Application Programming Interface) would be enabled from the server in the cloud 118 that would allow access of these emotional profiles to the social networking site. In a similar manner, the server in the cloud 118 may communicate the emotional profiles via an API (Application Programing Interface) to a networked game like Farmville.

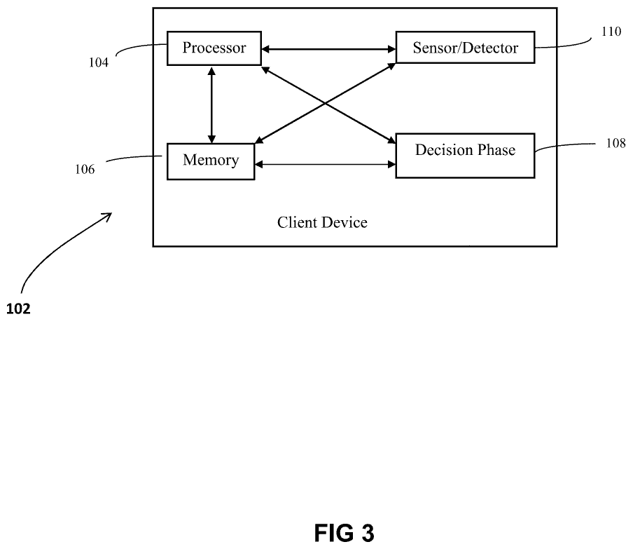

FIG. 3 illustrates the system module of a client device in accordance with an embodiment of the present invention. The client device 102 includes a module to capture the input data, a module to process this data to do feature extraction, a module for the decision phase and a memory to store the profiles. The module to capture the input data consists of a sensor 110 to capture the user's input. The Sensor 110 operates on different auditory, visual, text, location based, or other kinds of sensory inputs. The module to process the input data consists of a processor 104 that processes the input received from the sensor and sends it to the decision phase module 108. The decision phase module 108 utilizes the input to generate the emotional profile EP (n) 208 of the user. The generated profile is then stored in the memory 106 of the client device 102 and is also communicated to the central repository in cloud 118.

In an embodiment of the present invention the sensor 110 captures the input from a user in the form of auditory, visual, text, location based, or any other kind of sensory signal.

In another embodiment of the present invention, the module for decision phase 108 may be based on the instantaneous decision based on a single input, or a combined multi-modal decision that relies on multiple emotion sensors 110.

The client device 102 has the ability to capture various kinds of auditory, visual, location based, text based, and other kinds of sensory inputs that are used to detect the instantaneous emotional response of a user. The client device 102 then processes the above inputs and derives an instantaneous Emotional Profile (EP(n)) 208 for the user corresponding to the client device. The client device further has a mechanism to communicate the instantaneous Emotional Profiles to the cloud 118 and a mechanism to abstract a relevant set of Emotional Profiles specific to a particular application, and specific to a particular social network of an individual. The client device 102 is configured with a module for creating and updating the Emotional profiles, uploading the profiles to cloud 118 and for downloading from the cloud these emotional profiles that may scale across a variety of applications and verticals.

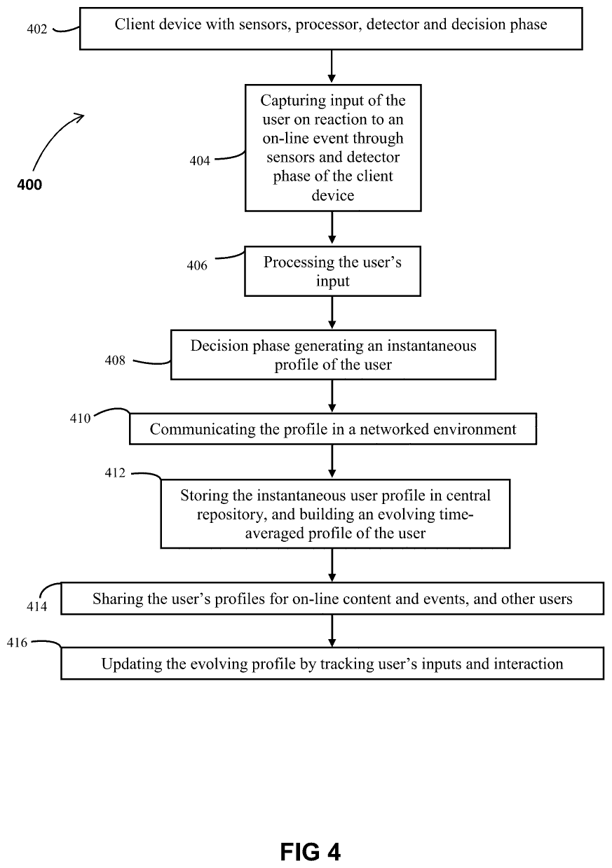

FIG. 4 illustrates a flow diagram depicting a process flow for generating an emotional profile for each uer and communicating it in the cloud network, in accordance with an embodiment of the present invention. The users are connected in the networked environment through their respective client devices. The client device 102 is having a sensor 110, a processor 104, a decision phase 108 and a memory 106 to generate the emotion profile 208 of the user, as shown in step 402. The client device 102 is connected in the networked environment 118 and is in interaction with online events and content 112. The client device 102 captures the input of the user in reaction to the online events and content 112, in step 404. The processor 104 of client device 102 then process the user's input and sends it to decision phase 108, step 406. In the next step 408, the decision phase 108 of the client device 102 generates an instantaneous profile of the user based on the response and reaction of the user to online content and events 112. The user profile is then communicated in the network environment 118 in step 410. This communication of profile in the user's network allows others to know the user's response to that content. In step 412, the instantaneous profile of the user is stored in the central repository and based on the continuous input, an evolving time averaged user's profile is created. The stored profile is then shared in the network for online content and events 112, in step 414. The user's inputs are continuously monitored by the sensor 110 and variation in the reaction and response of the user is tracked down over a period of time and these variations are used to update the continuous evolving profile, as described in step 416.

In an embodiment of the present invention, the user's profile is an instantaneous profile or a time averaged profile. The instantaneous emotional profile of the user connotes the instantaneous reaction of the user to online content or events. Whereas the time averaged profile of the user connotes the emotional response or reaction of the user over a period of time for a particular content, or the average of all reactions of the user to all online content or events over a period of time.

The Cloud/Server 118 has an ability to collect Emotional States of the users from a given set of allowed Emotional States. For each user the Emotional State is a template that is stored in the cloud that could get better, or more refined over time. Each user would register and choose his/her allowed set of Emotional States that could be used by a host of applications. The available emotional states of the users would then be shared according to user allowed set of applications and rules. For example, a user may select not only the applications, but also the granularity of the Emotional Profile/State that could be shared by different allowed applications.

The applications have an API (Application Programming Interface), or plug-ins, that enable usage of these Emotional Profiles in various ways to the allowed set of connections in the user's network.

The plug-ins for each application have predefined rules for customization for using the Emotional Profiles. These predefined rules are based on the desire or comfort of the individual to open up the granularity of the Emotional Profiles to a select group of network connections. For example, the user may select specific friend to which he wants to share the profile, or may also decide to choose which subset of friends can see what subset of Emotional Profile, and which subset of friends cannot see anything at all.

The user may also specify specific features of the given application that may be enabled by these emotional profiles, and in what manner, and to what extent. For instance, in a networked game, certain elements of the games could be triggered in a specific manner based on the Emotional Profiles of the user, and the user would get to customize which features he wants to use the cues from the Emotional Profiles.

In accordance with the method of present invention, the user of the client device registers to activate his or her emotional profile. Through the specific inputs entered by the user, the application puts the state of the user in one of the allowed states in the user's on-line emotional profile. The sensory inputs include, but are not limited to, voice cues, voice intonations, NLP (Natural Language Processing) based text interpretations of user's updates, texts, or blogs, text cues, facial recognition, smile detection, micro-expressions, sub-cutaneous changes, pulse detection, blood pressure variations, breathing pattern detection etc. After registering in the network, all the connected applications and user's friends/network in those applications become aware of the user's changed Emotional State. The various applications then have ability to react to this changed emotional state according to the rules of the application specific plug-in. This may mean simply knowing the Emotional State of the given user, or may imply reacting to various other actions that could be triggered by the current state of the user.

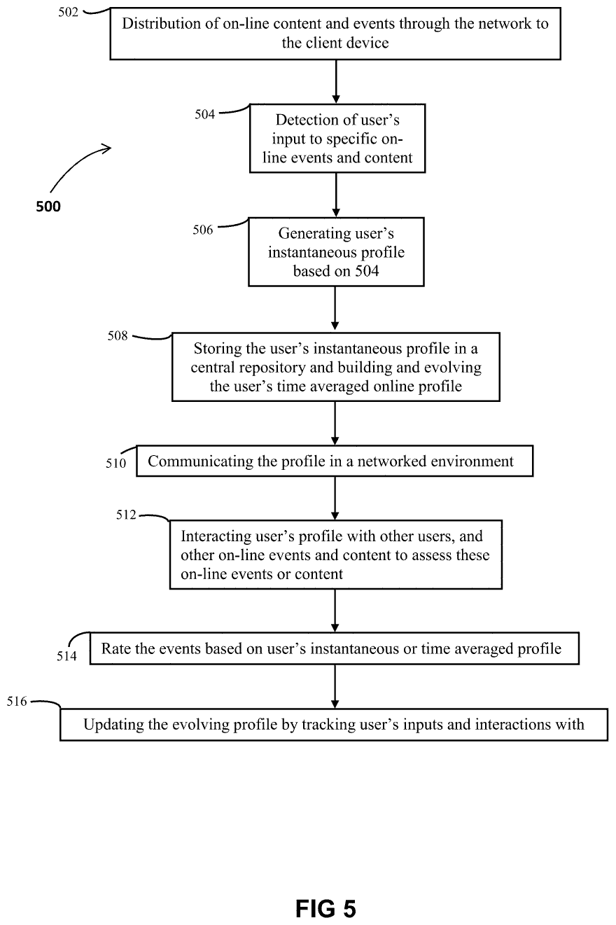

FIG. 5 illustrates an exemplary method to use the system for rating an online event and content in accordance with an embodiment of the present invention. In an embodiment, the method has the following steps: Step 502: The online content and events 112 are distributed in the cloud network 118. The content 112 is then communicated to the client device 102 in the network environment. Step 504: The users watch the content and his response is tracked down by the sensor 110 present in the client device. Different users have different response to the contents and thus their input is noted so as to rate the contents 112. Step 506: Based on the input of the user, the client device generates an instantaneous profile of the user 208. The profile shows the emotion or mood of the user after viewing the online content. Step 508: The generated instantaneous profile of the user is communicated in the cloud network 118 and a version of it is stored in the central repository. Different version of emotional profile of the user is stored in the central repository over a period of time. The central repository may reside in a geographically different place and is connected to the rest of the client devices in the network. It aids in generating and updating the user's time averaged online profile over a continuous period of time. Step 510: The generated time averaged and instantaneous profile of the user is communicated in the networked environment. The profile is shared in the user's network with a set of predefined rules. The profile is shared to those users in the network which are in user's circle and to whom user has provided authentication to share. Step 512: The user profile is then used to communicate the user's response to the content to other users. This will help the other users to know the feedback of different users to assess the rating of on line content and events. Step 514: The online content is assessed by rating them using a user's instantaneous or time averaged profile. Step 516: The client device continuously captures the user's input over a period of time in response to the content or event being watched. Based on the varying inputs of the user over a period of time, the profile of the user keeps on evolving. These sets of varying profiles are stored in the repository and a time averaged profile is generated which could then be used to assess or predict the behavior of the user for different kind of content in the future.

In an exemplary embodiment of the present invention, the method of the present invention may be used in online game systems to increase user experience. The application uses an instantaneous or time evolving emotional profile of all the users. The users may choose to activate or de-activate the use of these Emotional Profiles, or the granularity of the cues of their individual Emotional Profile that would be seen by others at a particular instance. During the time the user is playing the online game, the time-evolving Emotional Profile could be used to change the behavior of the game in any possible fashion. It could be used to create an instantaneous “Avatar” of the user for all users of the on-line game; it could also be used as an attribute to some function of the game, or act as an input to the game's state machine in any manner.

The method of the present invention may be used as an online tool to capture instantaneous reaction of online marketing campaigns, online polls, online likes and dislikes—this may be an extension of express how an individual, or a group of individuals, is reacting to a particular news, status post, Ads, marketing campaigns, comments on social networking sites, by capturing that individual's online instantaneous Emotional Profile. An extension of this may be quantifying the user behavior across a large community to an Emotional Profile Score that could be more than just plain “Like”/“Dislike”, or “Thumbs Up”/“Thumbs Down” by using integrable “Emotional Profiles” into existing online media formats.

In yet another embodiment of the present invention, the method of the present invention may be used in applications such as tracking employee behavior during remote interactions; integration with other enterprise applications to improve individual or group productivity; parents tracking of kids; educational applications where a remote teacher is able to derive value from remote student behavior in an on-line teaching environment; and as APIs (Application Programing Interfaces) to popular Social Media and Mobile Apps.

We claim:

1. A system for generating an emotional profile of a user in an interactive environment comprising:
an application configured to distribute online content or an event, or collecting data relating to an event;
a client device with a detector having at least one sensor to capture a real-time visual input of the user in the form of video to the online content or event that reflects an emotional state of the user;
a processor configured in the client device to process the real-time visual input to the online content or event to generate the emotional profile of the user;
a memory in the client device to store the emotional profile in a first version compatible with the client device;
said emotional profile is communicated to a repository in a server to store the emotional profile in a second version which can be accessed by at least one other user using a different client device based on a set of predefined rules created by the user;
wherein the server is configured to communicate the user's emotional profile for, or in reaction to online content and events in a predefined user's network and updating the user's emotional profile;

2. The system of claim 1 wherein the client device is a mobile phone, a smartphone, a laptop, a camera with Wi-Fi connectivity, a desktop computer, a tablet computer, or a sensory device with connectivity.

3. The system of claim 1 wherein the detector comprises a single module or plurality of modules which capture the real-time visual input from an individual; process the real-time visual input for feature extraction; and conduct a decision phase.

4. The system of claim 1 wherein the emotional profile is an instantaneous profile or a time averaged profile that is a combination of emotion, behavior, response, attention span, gestures, hand and head movement, or other reaction or stimuli of the user to the online content or event.

5. The system of claim 1 wherein the emotional profile is stored at the repository in the second version and is communicated to the at least one other user using a different client devices in the network through an application programming interface in a third version.

6. The system of claim 1, wherein the emotional profile of the user stored in the repository in the server is shared in the network based on the set of predefined rules.

7. A method for generating an emotional profile of a user in a network comprising the steps of:
distributing one or more of online content, online interactions and events to the user using a client device;
capturing, with a client device, real-time visual emotional inputs from the user in the form of video input data that reflects an emotional state of the user;
processing the real-time visual emotional inputs to generate the emotional profile of the user by one or more emotion sensors;
generating the emotional profile in a first version compatible with the client device and storing the first version in the client device;
storing the emotional profile in a central repository in a server, in a second version as a base profile;
tracking, by the server, the real-time visual input over a period and updating the base profile; and
sharing the base profile within the user's network through the server, to communicate the emotional state of the user.

8. The method of claim 7, wherein the network comprises a plurality of client devices configured with the server through the Internet, Local Area Network, or computer network.

9. The method of claim 7, wherein the client device is a mobile phone, a smartphone, a laptop, a camera with Wi-Fi connectivity, a desktop computer, a tablet computer, or a sensory device with connectivity.

10. The method of claim 7 wherein the emotional profile is an instantaneous profile or a time averaged profile.

11. The method of claim 7, wherein the emotional profile stored in the central repository is customizable for communication to the plurality of client devices in the network through an application programming interface in a version capable of running in different applications.

12. The method of claim 7 wherein changes in the visual emotional inputs over a time period are used to update the user's instantaneous and time averaged emotional profile.

13. A method for communicating an emotional profile of a user in a network of a plurality of client devices configured with a server comprising the steps of:
distributing one or more of online content, online interactions and events in the network;
capturing, with a client device, real-time visual emotional input from the user in form of video input data that reflects an emotional reaction of the user to the one or more of online content, online interactions and events using at least one sensor of a client device in the form of video input data;
generating, the emotional profile of the user using the visual emotional input;
storing the emotional profile of the user in a central repository in the server, in a first version;
tracking, by the server, the real-time visual emotional input over a period and updating the emotional profile of the user based on the real-time visual emotional input; and
communicating the emotional profile within the user's network through the server
wherein an application programming interface in the server is configured to communicate the emotional profile to at least one different application running on at least one other client device, in a version compatible with the at least one different application running on the at least one other client device.

14. The method of claim 13 wherein the client device is a mobile phone, a smartphone, a laptop, a camera with WiFi connectivity, a desktop computer, a tablet computer, or a sensory device with connectivity.

15. The method of claim 13 wherein the content includes multimedia, a web page, content on the internet, a web-interaction including a video conference, a group conference or a text document.

16. The method of claim 13 wherein emotional profile is an emotional state of the user.

17. The method of claim 13 wherein the emotional profile is an instantaneous profile or a time averaged profile.

18. The method of claim 13 wherein the emotional profile is stored in different versions or formats at the central repository and is customizable for communication to the plurality of client devices in the network.

19. The method of claim 13 wherein the emotional profile is communicated through the application programming interface in a version compatible with the different applications.

20. The method of claim 13 wherein the emotional profile is communicated fully or partly in the network based on a set of predefined rules set by the user for selected users in the user's network.

21. The method of claim 13 wherein the event comprises a communication between individuals, a location, or subject matter.

22. The system of claim 1 wherein the event comprises a communication between individuals, a location, or subject matter.
